(19) United States
(12) Patent Application Publication
(10) Pub. No.: US 2002/0147674 A1
(43) Pub. Date: Oct. 10, 2002

(54) System and method for specialized reverse auction

(76) Inventor: Kyle E. Gillman, Manassas, VA (US)

Correspondence Address: Robert D. Kucler, Esquire, Reed Smith LLP, P.O. Box 488, Pittsburgh, PA, 15230-0488, US

(21) Appl. No.: 09/826,286

(22) Filed: Apr. 4, 2001

Related U.S. Application Data
(60) Provisional application No. 60/194,535, filed on Apr. 4, 2000.

(51) Int. Cl. G06F 17/60

(52) U.S. Cl. 705/37

(57) ABSTRACT

An electronic buying system and method that dynamically matches, over the World Wide Web, a person or business entity requesting a specialized product with a person or entity capable of providing that product. The electronic buy system, which may function as a reverse auction, is utilized from personalized home pages for both buyers and suppliers. A buyer submit a request for a good including electronic specifications, and the suppliers respond to the request with bid proposals. The present system may include self-adjusting bids, and private auction centers, and suppliers may submit more than one bid for each specific request. The buyer may choose any bid, not only the lowest priced bid, as the winner.

This application claims the benefit of the earlier filing date of U.S. Provisional Application No. 60/194,535 which was filed on Apr. 4, 2000.

### FIELD OF THE INVENTION

The present invention relates generally to electronic buying systems and methods and, more specifically, the present invention relates to systems and methods for dynamically matching, over the World Wide Web, a person or business entity requesting a specialized product with a person or business entity capable of providing that product.

### BACKGROUND OF THE INVENTION

The rise of networked computing environments such as the Internet, and especially the graphical World Wide Web portion of the Internet (“WWW” or the “Web”), is rapidly changing the way that modern businesses market and sell their goods and/or services to buyers. Conventional business transactions, as practiced in the nonelectronic, non-networked world, may be imitated and in some instances improved by utilizing these cutting edge technologies. Because the Internet is global in scope, and further because electronic information is easier and less expensive to store, transmit and analyze than paper-based information, the Internet provides a unique opportunity for buyers and sellers to reach each other using novel approaches.

One such approach that has gained popularity in recent years is the electronic auction. Auctions over electronic networks have the potential to address large numbers of buyers by posting auction items (descriptions of goods and/or services) traditionally available only to those in the vicinity of the auction or to those who actively seek out the auction in some other manner. By vastly increasing the number of potential buyers with little or no marginal increase in the costs of administering the auction, a seller or supplier increases both the chances that a sale will be made as well as the likelihood that favorable sales terms will be realized.

In a similar manner, reverse auctions work to maximize a buyer's returns. In a reverse auction, buyers post the names and/or descriptions of products or services that they wish to purchase from one of a select group of suppliers. The suppliers bid against each other, using successively lower bids, in order to gain the opportunity to provide the buyer with the product or service. In the reverse auction system, the supplier with the lowest bid after a certain portion of time traditionally wins the right to supply the buyer with the product or service for that price. Reverse auctions allow buyers to obtain excellent prices on goods and services while minimizing the amount of comparison shopping necessary to obtain such prices. Reverse auctions may also benefit sellers in that sellers can acquire information about the pricing, terms and/or other conditions utilized by their competitors.

Although network-based reverse auctions have been used to acquire many different types of goods, a local reverse auction, dedicated to one particular type of good, may be particularly suited to certain industries. For example, in certain industries, requested goods are custom-made to a buyer's exact specifications. Because the goods are so specialized or unique, the various suppliers may each be well-suited to supply only one particular subset of the industry's total goods. In these “specialized” industries, a buyer may find it difficult to locate the proper supplier to supply a certain type of good. A large number of suppliers, all with varying pricing and delivery terms, are preferably reached through the network reverse auction in order to maximize the buying power of the buyer.

One such specialized industry involves the forging of metal. Although metal forging can be computerized and modern in approach, many forgings are bought in small numbers with non-standard forging specifications. Performing the various types of forging processes, including open die, closed die, and drop forgings, as well as creating seamless rolled rings, involves a highly particularized process that varies greatly depending on the desired specifications. The extreme variations in size, shape and materials, as well as the typically tight tolerances, make the specification and acquisition of forged metals a highly specialized process.

As such, the specification and acquisition of forged metals is often a wasteful process. Because each forging is so particularized (in size, shape and materials), there are often one or two particular forge shops best suited to provide the particular forging. Without a complete knowledge of all forging shops, it is likely that a purchaser or specifier will not receive the best value for their forging dollar. As such, a more streamlined process, with increased information flow, is desired.

By connecting buyers and suppliers directly with each other, the Internet is eliminating the “middleman” that is present in normal businesses, thereby working to maximize returns for both buyers and suppliers. With highly specialized products such as metal forgings, there may be the additional advantage that suppliers are able to educate buyers about which forge shops are well-suited to handle a certain type of forging. This approach also increases the information flow so both buyers and suppliers can participate in the transaction as educated participants.

### SUMMARY OF THE INVENTION

The present invention relates generally to electronic buying systems and methods and, more specifically, the present invention relates to systems and methods for dynamically matching, in a networked environment, a person or business entity requesting a specialized product (such as a metal forging) with a person or business entity capable of providing that product. The buying system may be implemented over the World Wide Web portion of the Internet as part of a collection of graphical web pages that are presented to both the buyers and the registered forging operations (suppliers).

A presently preferred embodiment of the invention may include a reverse auction as is common in the electronic marketplace. In the reverse auction, the buyer preferably specifies a good and/or service to be provided by a supplier. An applicable or pre-selected pool of registered suppliers who possess the ability to meet the needs of the buyer (either by manufacturing the desired product or through buying and reselling the product from another source) may then bid against each other to provide the good and/or service to the buyer. Ultimately, the buyer may select one of the bids as the “winner,” however, the buyer need not select the supplier with the lowest bid, or any supplier at all. After a determination of the winning supplier, the buyer may make appropriate arrangements with the supplier to conduct the sale, deliver the goods, and provide for payment of the goods.

The reverse auction system preferably offers registered suppliers a personalized home page from which the supplier may track, in real-time, all bidding opportunities that exist on the site. The system may also permit registered suppliers to track bids entered by themselves and/or “rival” suppliers. The reverse auction system may offer buyers a similar personalized home page from which the buyer may track the orders that have been placed by the buyer and permit the buyer to monitor other bidding operations in which the buyer may be involved or interested.

The reverse auction system, as used with the present invention, preferably allows registered suppliers the opportunity to submit multiple job quotes (bids) throughout the bidding time period for a single buyer RFQ (Request For Quote). By providing bids with varying price/delivery options, a seller may communicate a flexible bidding “scheme” to the buyer, rather than one discrete bid. The auction system of the present invention may preferably offer a self-adjusting bid feature where, once a bid of this type is placed, the offer of a selling price will be automatically lowered if a lower price is entered by a competing supplier. This feature may allow a participant to make a lower “initial” bid that will only be effective as needed. In this way, a bidder need not continually monitor a particular auction to succeed.

The reverse auction system also preferably allows the buyer to monitor the bidding process in real-time. Additionally, the reverse auction system may allow both buyers and suppliers (forging operations) to submit feedback regarding satisfaction with the process and/or the participants. This feedback allows future participants to better assess unknown partners, and it may even be used by the auction system administration to deactivate or otherwise discipline a particular user.

The auction system may also have a private bidding venue (private auction center) where only pre-approved suppliers have access to bid on a customer's request. This feature preferably provides a secure venue for participants which are familiar with each other to utilize the auction system. With this feature, buyers and sellers can form local closed auctions of approved users.

The reverse auction system may allow for the acquisition of both finalized forgings, as well as raw materials by suppliers using the same reverse auction methodology. Furthermore, the reverse auction may allow for the purchase of other supply categories as well as the possibility of storing and transmitting engineering drawings as part of the buyer's RFQ.

The present invention is not limited to those examples discussed above. These and other objectives and advantages of the present invention will become readily apparent to persons skilled in the art from the following description of the particularly preferred embodiments of the invention.

### BRIEF DESCRIPTION OF THE DRAWINGS

The present invention and its presently preferred embodiments will be better understood by reference to the detailed disclosure hereinbelow and to the accompanying drawings, wherein:

FIG. 1 is a block diagram of one embodiment of the system of the present invention;

FIG. 2 is an exemplary home page of the buying system of the present invention;

FIG. 3 is an exemplary buyer home page as part of the present invention; and

FIG. 4 is an exemplary seller home page as part of the present invention.

### DESCRIPTION OF THE PREFERRED EMBODIMENTS

The present invention preferably provides an integrated system and method for requesting and procuring specified products as part of an electronic reverse auction system. Although the present invention may be used for various types of goods and services, it may be especially adapted to provide goods and services in a highly specialized field, where there is great variety between various products and where certain suppliers are better suited to provide certain types of goods or services. As such, the present invention will be described in terms of a reverse auction system servicing the forging industry, but this particular selection of industry should not in any way limit this detailed description or the claims attached hereto.

In a preferred embodiment, the reverse auction system of the present invention is comprised of various computers, databases and other electronic hardware and software which hold information about users (both buyers and suppliers) of the system, as well as information about the goods or services auctioned on the system. Both buyers and suppliers (collectively “users”) of the system are preferably able to create, modify, utilize, and interact with the information database and computers through a graphical user interface, which may consist of a series or collection of web pages sent over the Internet. These web pages preferably provide an intuitive user interface to the present buying system.

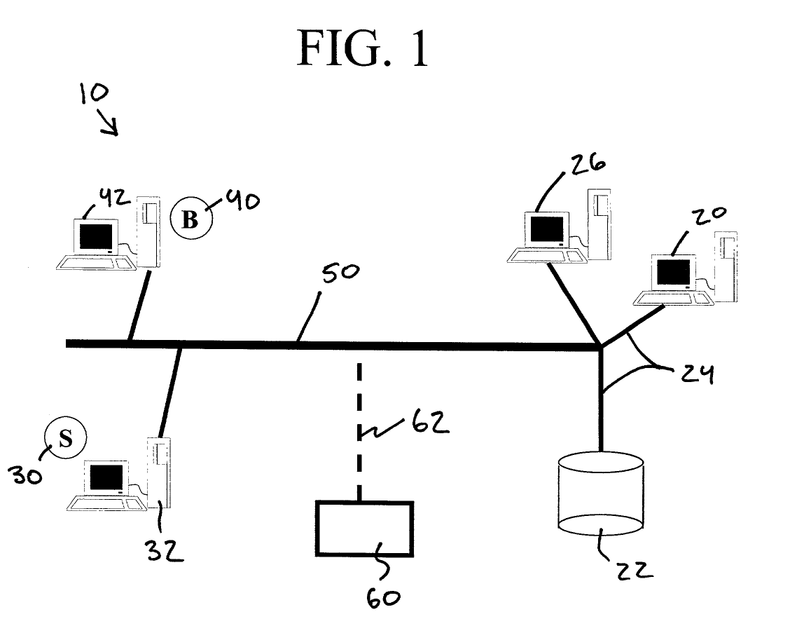

FIG. 1 shows one manifestation of the hardware that is used to implement the web-based reverse auction system 10 of the current invention. In FIG. 1, one or more reverse auction system computers (PCs or servers) 20, 26 databases 22, and communication links 24 housing the reverse auction web site and associated data are connected to each other. Various suppliers 30 and buyers 40 may access the reverse auction system 10 by means of a direct Internet connection.

In a preferred embodiment of the present invention, the reverse auction system 10 exists as part of one or more electronic or computer networks 24 that may be connected to each other by or through the Internet 50. At one location, the web pages, databases 22, programs, and computer hardware used to operate and run the reverse auction system may reside on a web server 20 or some additional type of computer system. The web server 20 may include other computer servers, personal computers, or any other electronic equipment 26 or storage devices connected to the web server 20. This web server 20 preferably will house all of the web pages that are presented to the buyers, suppliers, and other third parties that may use the reverse auction system.

Buyers 40 and suppliers 30 may gain entry to this web-based system 10 by logging onto the Internet from any computer or other device that is capable of accessing web pages. This is accomplished by entering the Uniform Resource Locator (URL) of the auction web site into a web browser or other viewing software. The buyer's computer or computer network 42 may be physically located remotely from both the system web server 20 and/or the supplier's computer 32. The buyer's computer and/or network 42 may communicate with these computers 20, 32 and/or networks through the Internet 50. Typically, both buyer and supplier users will access the auction system through an Internet Service Provider (“ISP”) that enables the uses to log onto the electronic bidding system 10 via the World Wide Web.

Additionally, communication media other than a wired Internet 50 connection may be used to access the reverse auction system. Specifically, access may be attained using various mobile devices 60 and platforms (such as personal digital assistants (PDAs), digital cellular handsets, and wireless palmtops) that utilize wireless communication networks 62. Connecting the relevant parties in electronic auctions and other buying methodologies over wireless communication networks will preferably use the Wireless Application Protocol (WAP) markup language and transport protocol. With WAP technology, buyers and sellers are able to perform multiple actions over the wireless medium equivalent to that over the Internet medium such as participating in an auction, checking/tracking the status of an auction, monitoring other bidding operations in which the buyer may be involved, and/or submitting feedback regarding the process and the participants. This application may also allow suppliers to submit multiple job quotes throughout the bidding time period, to track the status of their bids, their account, and other various offers via wireless methods.

The above description details a general hardware/software description of the present invention. A general description of the site's use will now be given. The users, both buyers and suppliers of the system, preferably need to register before gaining access to the site. Thereafter, a login screen name and password may be used to gain full use of the system. Preferably, users are given a personal home page which provides easy access to the various features of the site.

In a preferred embodiment of the present invention, the electronic buying system is buyer-driven. Generally speaking, the auction process begins when a registered buyer describes a good and/or service which it wishes to procure by filling out an electronic RFQ (Request For Quote) submission form. This form preferably prompts the user to provide certain information about the product (e.g., product type, description, specification, price, and delivery date), in this case a metal forging, to which interested suppliers may provide responses (preferably including counter-terms such as the supplier's suggested price, delivery date or schedule, and any other relevant terms and conditions for providing the product to the buyer).

Using the electronic reverse auction system to procure (buyer) and/or provide (supplier) forged goods, preferably reduces the amount of paperwork involved in procuring specialized materials. Additionally, a supplier may have reduced marketing costs (because the buyers “come to” the market), and the buyers may have a reduced cost in terms of locating new supplying forge shops to provide the buyers particular type of forging. The suppliers may also benefit from the increased amount of information flow about both their own, and competitors price quotes. Finally, by examining the winning bid specifications, a “losing” supplier may be able to compete more effectively in a similar future auction.

The submitting or posting of an RFQ is preferably at no cost to buyers registered with the system. The RFQ describes or specifies the requested forging or other product in such specific terms as to enable a supplier to make an informed bid for the provision of the good. The RFQ may include all of the specifications for the desired forging (type, size, material dimensions, tolerances) as well as optionally including an electronic copy of the blueprints or other printed specifications for the forging. These blueprints may be uploaded to the system by the buyer, or a hard copy of the prints may be sent to the system administrators for scanning and posting as part of the RFQ. The RFQ will also preferably state an “end date” after which time the buyer will no longer accept responses to the particular RFQ (i.e., closing the auction). In emergency or immediate procurement situations, an auction may be open for only a matter of hours. In more normal situations, the auction may be active for weeks or even months.

When submitting an RFQ to the system, the buyer is preferably not obligated to purchase that particular forging at the close of the auction period, or at any time thereafter. Should the auction expire or be stopped by the buyer (see below) without a “winning” supplier being selected in a reasonable time thereafter, the system may charge the buyer a “placement fee” for utilizing the auction system.

Once completed, an RFQ is generally posted to the entire community of suppliers. This general publication allows the buyer to reach a maximum number of suppliers with a small amount of effort. This process saves the buyer the traditional time and expense of sending a paper copy of a proposal to each potential supplier. Once an RFQ is posted to the system, all of the intended recipient suppliers are preferably sent an email notification message from the system to indicate that an auction has been directed to them (or is available for the supplier's response). This broad reach is also an inexpensive way for buyers to learn about the forging capabilities of new forge shops, which may be difficult in the “real” world.

Rather than publishing an RFQ to the general population of suppliers, a buyer may target a selected group of suppliers (forge shops) to receive a certain RFQ for bidding. For example, the buyer may have a prior relationship with a selected group of shops, or the buyer may know that certain shops produce high quality forgings of a certain type (e.g., open die, closed die, or rolled ring forging). The reverse auction system preferably includes the capability to set up a private auction center, or private auction booth, in which only selected suppliers may enter to view and respond to certain RFQs. Buyers that have one or more private auction centers may still publish a particular RFQ to the general population of suppliers. This may be a good “check” to make sure that the selected “private” suppliers are offering competitive pricing, delivery, and other terms.

A buyer preferably interfaces with the system and keeps track of all of its auctions through a personalized buyer home page. The buyer home page is just a web page keyed to certain aspects of a buyer's user profile and auction history. The buyer home page preferably allows the buyer to keep track of the orders that have been placed and to monitor the buyer's ongoing auctions. The home page may store and display information about the buyer's completed (time expired) auctions that have not yet resulted in an order by the buyer, and the home page may also hold “partial” RFQs that have been written or specified to some degree, but have not yet been published to the suppliers for bidding (submitted to the system). The home page may also keep track of various information relating to past completed auctions. These auctions are represented in these home page sections.

Multiple individuals (buyers) from the same buying organization may also have their own separate buyer's home page. In this way, the system may distinguish between an individual buyer and the group to which that buyer belongs. Again, the buying organization should provide measures to ensure that two buyer's from the same organization do not submit an RFQ for the same forging.

The suppliers preferably view the specifications, terms and conditions of an RFQ, and decide whether or not to respond to or counteroffer the RFQ. When responding to a particular RFQ (i.e., “bidding” on the RFQ in reverse auction format), the suppliers' identification is preferably maintained in anonymity to the buyer. The bid may be indicated only with the supplier's screen name or no identification at all may be given. This secrecy may prevent a buyer and supplier from contacting each other outside of the system to consecrate a deal for forgings without utilizing the system.

The supplier likewise preferably keeps track of its current RFQ auctions as well as potential new auctions from its supplier home page. The supplier home page preferably allows the supplier, in real-time, to track all of the bidding opportunities available to that particular supplier on the system. The supplier may also track the current state of its bids in open auctions, and the supplier may review the bids submitted by competitors (other suppliers). Preferably, the supplier accesses their home page through a web browser from anywhere in the world, including their desktop.

Multiple individuals from the same supplier forge shop may register with the site separately and may maintain their own separate home pages. In this way, forging supply personnel who specialize in different types of forgings may each maintain their own home page with their own relevant information even though the same forge shop will create or supply the actual end product. It is preferable for such multi-user shops to maintain internal communication to prevent more than one supplier from the same shop from bidding against each other.

A supplier responds to a buyer's RFQ by inputting various information about its proposed supply of the requested forging. Specifically, suppliers will generally provide a price and delivery date as well as any additional terms and conditions the supplier desires to add to the deal. Likewise, if a supplier needs additional information about a particular RFQ, the system may allow for a direct question to be posed to a buyer (e.g., by email) or the system may forward the request to the buyer itself. Many different communications schemes are possible.

As the auction progresses (until closing), the various invited suppliers preferably bid on providing the requested good or service. The system communicates these bids to the user, preferably including all terms and conditions, as part of a table or matrix of bids. Preferably, the user may view the bids in progress and follow the auction in real-time.

The electronic buying system may also allow a supplier to bid on an RFQ using a self-adjusting bid. A self-adjusting bid gives a supplier increased bidding flexibility while decreasing the amount of time spent watching an auction progress. With this type of bid, the supplier's offer will be automatically lowered if a lower price is entered (bid) by a competing supplier. The supplier preferably determines the bid increment (decrement) for this type of bid, and the supplier also preferably has the ability to specify a floor below which the supplier's self-adjusting bid will not go. Preferably, each time the system automatically lowers the users bid price, the system will also notify the supplier that such action has occurred (e.g., by email). This type of bid allows a supplier who is willing to offer a very low price, to only reach that lowest price if other bidders have interceded with their own lower prices. Traditionally, a supplier would be forced to monitor the auction and continually update its bid in response to competitive bids.

A supplier may also submit more than one bid or response to each RFQ for which they qualify. For example, in response to a particular RFQ, a supplier may offer a price $X for a certain delivery date for a forging. As the auction progresses and the competing prices drop, that same supplier may alter its previous bid or enter an entirely new bid that offers to provide the requested forging at a price of $X-10 if the delivery date is moved out an extra week longer (or a cheaper material can be used). Likewise, a supplier may submit a third bid that raises the price of the forging in exchange for a shorter deliver date (or different terms and conditions attached). There is preferably no requirement that successive bids be lower in price than past bids by the same or another supplier. With multiple bids, a supplier is able to communicate a bidding “range” or scheme to a buyer, rather than just a single price and delivery schedule. Alternatively, a supplier may even “no quote” an RFQ if that supplier is unable to meet the delivery deadline listed in a particular RFQ. With a “no quote” bid, the supplier offers a price only which can be accepted by the buyer if the buyer's delivery schedule is flexible (or becomes flexible at a later time).

A buyer who has submitted an RFQ may have the option to close the auction early or before the “end time” specified in the initial RFQ submission form. As is customary in the forging industry, buyers may close the bidding early if the forging's price and/or delivery terms have been satisfactorily met. In other circumstances, a manager at the buyer's company may direct the buyer to immediately accept the current lowest priced bid (for some emergency reason). Preferably, the system allows the buyer to have broad discretion to prematurely end the bidding, whether or not a “winner” is chosen and/or a deal for the forging is consummated.

At the close of the time period for an auction, a buyer is preferably given a predefined time period in which to decide whether or not to view the identification information for the bidding suppliers. Recall that the bidding is preferably performed anonymously. If a buyer has not chosen to view all of the actual supplier identification information, the buyer may preferably cancel the auction and just decide not to accept any bids or discover the identity of the suppliers. In this case, the system preferably assesses the buyer a small fee for utilizing the system to obtain a “price quote.” This fee may be approximately $100 per price quote.

During the auction, all of the suppliers are preferably able to view all of the bids (including terms and conditions) of all other suppliers while the auction is progressing. These competing bids are preferably anonymous to the supplier. This increased information flow allows a supplier to better judge its bargaining position against its competitors and allows the buyer to receive the best price and/or terms for their forging (because of the open market). However, in a private auction center (briefly described above), only those suppliers invited into the private auction center are able to see the bids and terms. “Outsiders” preferably may view neither the RFQ nor any bids or responses to that RFQ.

Once the auction time period closes (either according to the “end time” or through the buyer's premature ending of the auction), all of the participants (buyer and suppliers) are preferably notified of the end of the auction by email or some other means. As stated above, buyers will preferably not know the supplier's true identity until after the bidding closes. Upon closing, the system will preferably prompt the buyer whether it wishes to see the identity of the bidding suppliers. If the buyer chooses to view the supplier identification information (e.g., by selecting a dialog box with a computer mouse), the buyer is preferably thereafter contractually bound to purchase the forging on the system (pursuant to the terms of the buyer's agreement). If the buyer does not thereafter purchase the forging on the system, the buyer may be liable for the commission (3% of the lowest bid) that would have been paid to the system by the winning supplier. Once the buyer chooses to move forward and identify the suppliers, all of the suppliers are again emailed a notification at this point.

After identifying the suppliers, the buyer may choose a “winner” of the auction to provide the forging according to agreed terms. The buyer choosing a winner of the auction is preferably not limited to selecting the supplier that has bid the lowest price and/or the best delivery terms. As is the custom in the general forging industry, the buyer is free to choose any of the suppliers who bid on the RFQ, regardless of the terms specified. In these specialized industries, external factors (such as reputation for craftsmanship/promptness or prior history) may outweigh the absolute benefits of low price and favorable delivery terms.

When a buyer chooses the winner of the auction, all of the suppliers are preferably given a notification that the buyer has made its selection and the identity of the winning supplier is revealed. These “losing” suppliers may then view the terms of the accepted bid and are put in a better position to bid on the next similar forging, or the next forging from that particular buyer. After the buyer makes its selection, the buyer and supplier preferably need to consummate the transaction outside of the parameters of the system. Preferably, the supplier then has to pay a commission to the system for the match. This commission may be approximately 3%, or some other discount over current industry practice. Failure to pay a commission may result in the supplier's dismissal from the site and/or other contractual penalties.

The electronic buying system is preferably utilized by buyers and suppliers all across the world. Because all users are preferably connected through the Internet or some other communications medium, the barriers of geography are virtually non-existent. However, because some buyers may wish to only buy certain forgings from suppliers from a certain country (e.g., the U.S. military may only wish to purchase from domestic suppliers), there is preferably a selection block or other indicator in the RFQ that can limit the posting of the RFQ to suppliers in a certain class. This country-specific class may be expanded to other such class restrictions.

The above description generally reveals the parameters of at least one embodiment of the present invention. To aid in understanding, the following description will provide additional detail about preferred embodiments, referencing figures where appropriate. For purposes of this discussion, it is assumed that the user is logged onto the Internet, has reached the auction site home page, but has never registered to use the system.

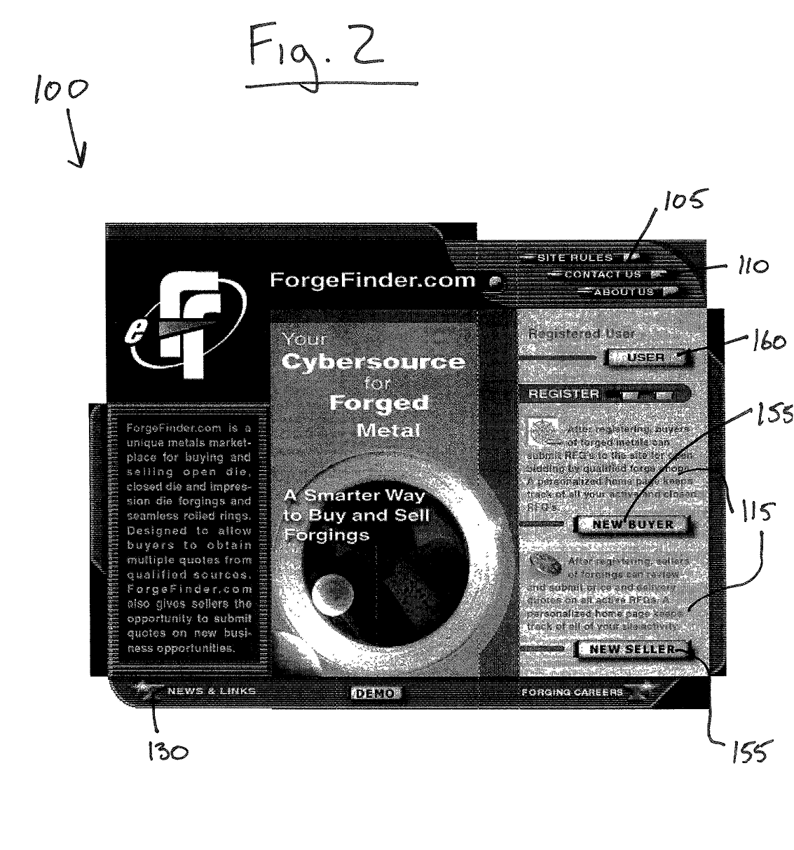

Once a user (either a supplier or a buyer) is connected to the system by some communication means, FIG. 2 shows one example of a web-based home page 100 for a reverse auction system according to the present invention. This home page 100 may preferably present a user with various option for viewing, navigating, and/or manipulating the various features of the system. The particular layout and design shown in FIG. 2 provides a working diagram for the purposes of example and clarity but is not intended to limit the scope of the present invention in any way.

A general system home page 100 may preferably contain links to help pages containing web site rules 105, contact information 110, general information for buyers and suppliers 115, frequently asked questions, events, news and/or press releases, buyer/supplier agreements, descriptions of fees, membership eligibility information, and/or privacy policies. As the main vehicle into the site, the system home page 100 will preferably also contain links 155 or other devices that allow new buyers and new suppliers to register with the site, as well as one or more links 160 that allow previously registered buyers and sellers to log into the system. There may also be links 130 to system news or other information sources.

As described above, prior to using the system, both buyers and suppliers preferably must set up an account (register) with the reverse auction system. This registration allows the reverse auction system to ascertain the identity and/or integrity of the potential buyers and/or suppliers. There may be a prequalifying credit check or some other requirements that must be satisfied before a registration is considered valid by the system. The registration also allows the system to set up and keep track of user preferences and history as part of a user profile. Keeping track of user accounts or profiles may be useful in allowing the system to record historical information about the buyers and suppliers so that some or all parties may utilize the system more effectively. Additionally, registration may be used to keep track of inappropriate actions of site users.

To register with the system as a buyer, a potential buyer selects the appropriate registration link 155. Buyer registration may require that businesses and/or individual buyers provide demographic and payment verification information about themselves. Examples of this type of information may include the buyer's name, email address, and telephone and fax numbers. Buyers may also be required to select a login name (screen name) and a password for verification purposes in future auction sessions. All of this information may be used to construct a user profile that is housed in a system database. The system may further request a mailing address, backup contact information (which will serve to identify a backup contact in the event that the user is unavailable and the system or one of the forge shops bidding on the user's RFQ requires additional information), and other relevant information.

Once this preliminary information is offered, the system preferably allows the buyer to identify the supplier's forge shops through which it normally procures its forgings. Listing the shops individually in the space available may allow the auction system to contact these suppliers on behalf of the buyer to make sure that the shops continue to receive the opportunity to respond to the buyer's RFQs. This additional registration section may potentially be more important if buyers already have a core group of qualified forging suppliers. For example, this pre-selection process may also be useful in setting up private auction centers in which only certain suppliers are invited to participate. However, a buyer is preferably not required to list any forge shop in the space available in order to complete the buyer's registration.

Additionally, the buyer registration process may include an opportunity to identify the name of the buyer company for which the buyer works. The system may use this information to both verify the registration information and affiliate (associate) the buyer with any other buyers from the buyer's company who may be registered with the system. The system may also request that the buyer list the contact information for the individual who is authorized to execute the web site buyer agreement on behalf of the buyer's company. Finally, the buyer will preferably be requested to provide the web site with the URL for the buyer's company web site.

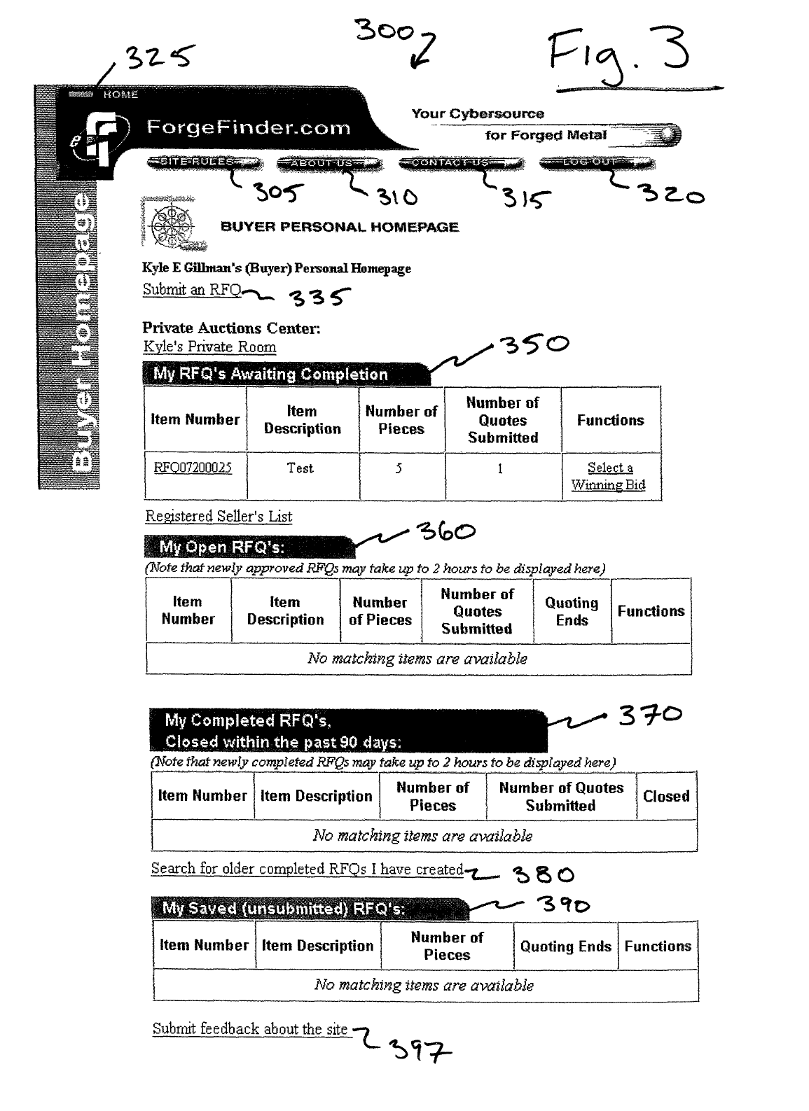

After supplying the necessary registration information, the buyer may be presented with a text version of the system's Buyer Agreement. This agreement preferably states the contractual terms and conditions associated with the use of the system. As described above, a buyer preferably needs to accept the terms of this agreement in order to use the system. At the end of the Agreement, the buyer may be able to “click” on a dialog button to either accept or reject the terms of the Buyer Agreement. Accepting the Agreement completes the buyer registration process, and the system will present the buyer with their own personalized home page (see, FIG. 3) on the system.

The newly registered buyer may have the ability to immediately enter or post an RFQ (Request for Quote) to the bidding portion of the system. The system may also request a written version of the agreement be signed and mailed or faxed to the system administrator. Alternatively, refusing the terms of the Agreement preferably will not terminate your registration process, but may result in the buyer receiving a message stating a problem was encountered in the processing of the form. Further, the buyer may be notified that it must agree to the fee agreement prior to being able to register with the web site. The system may allow account activation from the web site or by telephone at a later time.

A potential supplier preferably goes through a similar process to the buyers to register with the system. Initially, the supplier chooses the appropriate registration link 155 from the system home page 100 and begins by providing general demographic registration information. Specifically, a supplier may be asked to provide demographic and payment verification information about the supplier. Examples of this type of information may include the supplier's name, email address, mailing address and telephone and fax numbers. Suppliers may also be required to select a login name (screen name) and password for verification purposes and to provide future secure sessions. All of this information may be used to construct a supplier user profile that is preferably housed in a system database.

As with the buyer registration, the supplier may also be asked for backup contact information (probably not required). This information is recommended in the event that the supplier is unavailable and the system or a forging buyer requires additional information from the supplier.

Additional supplier registration sections preferably allow the individual supplier to associate itself with a specific forge shop or shops. There may be a “SEARCH” dialog button that allows the supplier to conduct a search of the auction system to determine if someone from the supplier's shop has already registered with the system. If an individual from the supplier's forge shop has already registered with the system, that information will preferably be presented for verification and acceptance. The individual supplier will then be associated with this forge shop on the system.

If no companies match the search criteria, then the supplier preferably will be given the opportunity to: 1) register its “new” company; 2) attempt to search again; 3) cancel the registration process; or 4) go back to the previous page to alter other registration information. If the supplier elects to register a new company with the system, the supplier may first be asked to enter a company name. After entering the company name, the only other required information preferably relates to the name, phone number and email address of the individual authorized to execute the system Supplier Agreement (comparable to the Buyer Agreement). After entering this information, the supplier may submit this information to the system for processing. If all the required data was entered successfully, the supplier will be associated with that new company on the system.

An additional section of the supplier registration process may ask the supplier for information that is not mandatory to complete the registration. Specifically, the page may request the supplier identify buyers from whom the supplier would like to receive submitted RFQs. The additional information may indicate if the supplier would like to see all the RFQs placed on the system or just a specific category or if the supplier would like to enter any additional information about the supplier forge shop's capabilities (i.e., types of forging available). Regardless of whether the supplier completes any information on this page, the supplier may preferably move on to the body of the system Supplier Agreement.

The system Supplier Agreement is preferably provided to the supplier in its entirety. The Supplier Agreement sets forth the terms and conditions with which the supplier must agree before utilizing the reverse auction system. At the end of the Supplier Agreement, the supplier may have the option of either accepting or rejecting the terms of the Agreement. Failure to agree to the terms and conditions of the web site supplier agreement may result in a supplier's registration being unfinished, and it may result in a supplier receiving a message indicating that a problem was encountered in processing the supplier form. Preferably, the supplier must agree to the fee agreement prior to it receiving full access to the web site.

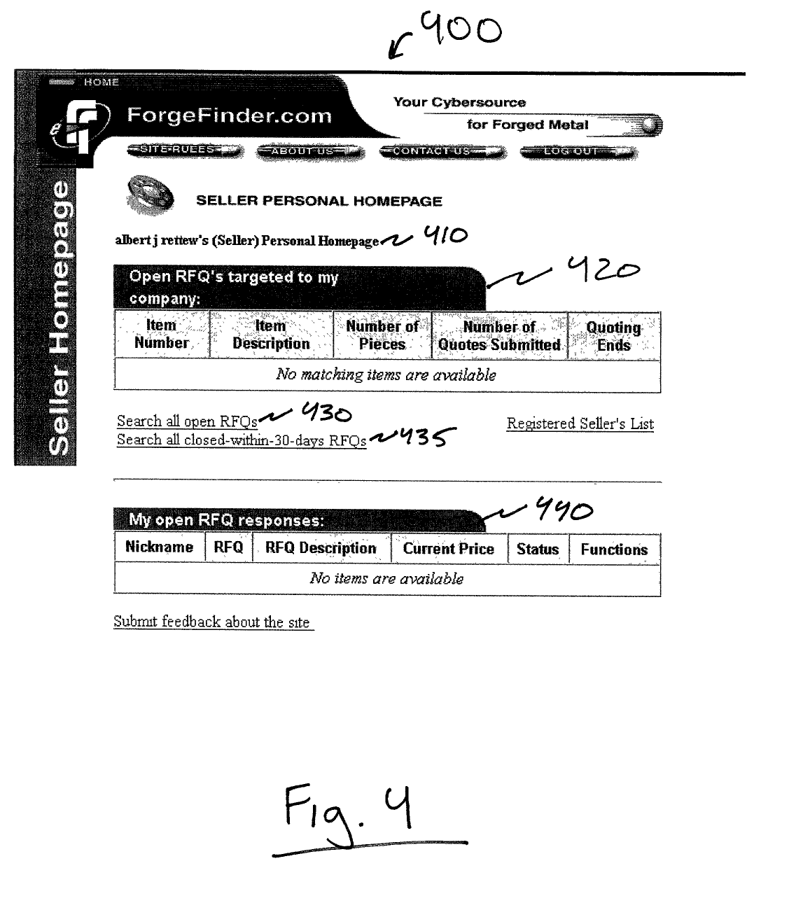

Accepting the Supplier Agreement preferably enables the supplier to be taken to the supplier's own home page (see FIG. 4) on the system web site. The supplier's personal home page preferably provides the user with an informative and intuitive user interface with which the supplier can utilize the features of the reverse auction system. This home page may provide the supplier with the ability to immediately review and respond to RFQs. Finally, the supplier preferably will need to print and sign an copy of the supplier registration agreement and send it to the web site offices to fully complete the registration.

After registering (either buyer or seller) the user is preferably ready to submit and/or bid on RFQs for forged metal or other products. To utilize all the features and services of the reverse auction system, including buying and selling forged metal products, a user must first log into the reverse auction system. Following registration, or during each future session on the system, a user may select (or “click” with a computer mouse) a “user” button or other login device. Such action will preferably prompt the user to enter their login name (screen name) and password as created or assigned as part of the system registration process. The user preferably will enter their username and password and then may submit this information to the system. Once logged in, the user will be able to participate in the reverse auction system. If a user does not log into the system (or has not registered with the system) the user may still have access to the site rules, contact info, about us, and/or news & links areas of the system. However, the user preferably will not be able to participate in the buying and/or selling. This “guest-style login” may pique the interest of some buyers and suppliers and cause them to join the system.

As stated above, both buyers and suppliers registered on the system are preferably given home pages from which to navigate and utilize the system. The following sections describe the use of the buyer and seller home pages.

As shown in FIG. 3, the buyer home page 300 preferably has links to site rules 305, “about us” 310, and “contact us” 315 areas of the system web site similar to the system home page. The buyer home page may also have a “log out” link 320 that enables the buyer to log out of the system. Additionally, the home page may include a “home” link 325 that may, when selected from interior web pages, present the buyer with the initial screen of the buyer's home page or the system home page.

On the buyer home page 300 there may be a selectable device or other pointer that allows a user to update their personal information. Selecting this link preferably provides the buyer with the initial registration screen. From this screen the user may add to or change any of the information they initially entered.

The buyer home page 300 may also contain a hyperlink 335 that will enable a buyer to submit an RFQ. This is the process by which a buyer specifies a good or service to be provided. By selecting the hyperlink 335, the buyer is preferably presented with an RFQ submission form in which the buyer can specify products. The RFQ submission form prompts business and individual buyers to provide demographic information about themselves as well as necessary production-specific information. For example, the form may be presented with an auto-assigned RFQ ID (designating this particular RFQ with the system). The form may request information, including the buyer's name, company name, street address, city, state, zip, phone number, fax number, and/or email address. This information may also be input directly from the buyer's profile.

After the buyer's personal information has been entered, the RFQ submission form requests a description of the requested product, the desired quantity, the expected date of delivery, the desired material, the part number, and the form may provide a section for specifications. Specification requests may include the forge type required (e.g., open die, closed die, or rolled ring) and/or a complete description of dimensions of the forging.

The RFQ submission form may also query whether the buyer will accept bids from non-U.S. forge shops. The buyer preferably will activate this feature by “clicking” on (and/or filling in) a circle (dialog selection box) stating that non-U.S. bids will or will not be considered. Alternatively, the RFQ submission form may request an expiration date after which non-U.S. bidding will not be allowed.

The next RFQ submission form may request further information about specifications of the particular requested forged material. This additional information may include a request for the particular type of forge required, which may take the form of a drop-down menu with “open die,” “closed die,” “rolled ring,” and/or “cold forging” listed. The forge type may appear as one or more pull-down menus, but the list could also be a list of selectable or hyperlinked words, tables, buttons, or other selectable devices. There also may be a space for the buyer to enter dimensions of the forging required (shaft dimensions, outer diameter, thickness, diameter length or OD/ID/thickness as applicable). Finally, the buyer may be capable of uploading a digital image or blueprint (in any common electronic inquiring format) of the requested forging to be included in the RFQ. Alternatively, the buyer could send a hard copy to the system for scanning and posting.

After the RFQ is complete and the buyer has cleared it for accuracy, the buyer preferably submits the RFQ for posting on the system to the designed suppliers (all suppliers or a selected group in a private auction center). Once posted, the auction is open for accepting bids from qualified suppliers.

At any time during the RFQ generation process, the buyer may halt or temporarily cease the creation of an RFQ. Later, after more information is obtained, the buyer may choose to continue drafting (filling out) the RFQ.

The buyer home page 300 also contains several sections which show various subsets of current or past auctions. For example, there may be a list of the buyer's RFQs awaiting completion 350. This list 350 preferably will include RFQs on which the buyer has closed bidding but still needs to select a winner and complete the deal. The list 350 may contain information about the RFQs such as item number, item description, number of pieces, number of quotes submitted, and functions.

There may be a list 360 of the buyer's open RFQs or RFQs awaiting completion. This list 360 preferably includes RFQs that the buyer currently has open or is accepting bids (ongoing reverse auctions). This list 360 may contain information about the RFQs such as item number, item description, number of pieces, quoting ends, and functions. Again, the buyer preferably navigates this section to watch the ongoing auction and decide if and when to prematurely end the auction.

Additionally, there may be a section 370 of the buyer home page which preferably includes RFQs posted by the buyer which have been closed in the past 90 days (or some other defined time period). This list 370 shows recent auction activity to guide the buyer in the future. Again, the list 370 may contain information about the RFQs such as item number, item description, number of pieces, number of quotes submitted, and functions.

The buyer home page 300 may also include various “SEARCH” links 380 to locate present or past RFQs. For example, there may be a link 380 which allows the buyer to search for older, completed RFQs which the buyer has created. By choosing this link 380, a search page is presented which allows the buyer to retrieve and view completed RFQ information. RFQs may be searched for individually by entering the RFQ ID, and/or in groups by entering dates between which RFQs were completed. Having entered the above information, the user may submit the query to receive the search results. Alternately, the buyer may cancel the search by selecting a dialog button to return to the buyer's home page. This will preferably present the buyer with his or her initial home page.

The buyer's home page may include a section cataloging saved (unsubmitted) RFQs 390. This section 390 preferably includes a list of the buyer's RFQ descriptions that have been saved but have not yet been submitted to the system for publication to suppliers. The list 390 may contain information about the RFQs such as item number, item description, number of pieces, quoting ends, and functions. Preferably, the buyer may select one of these partially complete RFQs and complete the RFQ.

The buyer home page 300 may also include several hyperlinks enabling the buyer to search all open RFQs and search all closed-within-365-days (or other time frame) RFQs. These links provide the buyer with the ability to search for and maintain all “public” activity on the reverse auction system. The first search engine allows the buyer to search for RFQs with certain characteristics within all the open RFQs (in addition to its own RFQ), and the second search allows the buyer to search for RFQs with certain characteristics within all the RFQs that were closed within the past year (recent RFQ search).

Finally, the buyer home page 300 may include links 397 that allow buyers to submit feedback about the site and/or request information. Using these feedback links 397, the buyer is preferably able to submit comments, observations, and/or queries to the system via email. The buyer's home page also may include a logout link or dialog button. By selecting the link, the system will log the buyer out of the system, and return the buyer to the main system login page.

The supplier's home page 400 (FIG. 4) is preferably very similar to the buyer home page 300 just described. Once logged in, the supplier will be presented with their personal home page 400, tailored specifically to the supplier logged into the system. The supplier home page 400 is preferably identified by the user's login name (or screen name) at the top of the page, along with their status (either buyer or supplier). The supplier's personal home page 400 may include the previously mentioned links to the site rules, “about us” and/or “contact us” areas of the system web site. The supplier home page 400 may also have a “logout” link that enables the supplier to log out of the system. Additionally, the home page may include a “home” link that, when selected from interior web pages, presents the supplier with the initial screen of its home page or the system home page.

The supplier home page 400 preferably includes a selectable device 410 that allows the supplier to update its personal information. Selecting this link 410 may present the supplier with the initial registration screen. From this screen the supplier may add to or change any of the information they initially entered (discussed above).

The supplier's home page 400 may also include, as did the buyer home page 300, a series of table or menus of various subsets of RFQs. For example, there may be a list 420 of open RFQs targeted to the supplier's company or preference for forgings. This list 420 preferably includes open or on-going RFQs in which the buyer specifically requested that the supplier be involved with the quotation process. Preferably, these “targeted” RFQs are established by a buyer who has a prior relationship with the supplier (i.e., this forge shop is on the buyer's selected shop list. The list 420 may include information about the RFQs such as the item number, item description, number of pieces, number of quotes submitted, and/or RFQ ending date/time. This list 420 of RFQs may also include any RFQ to which the user may respond, depending on the site and/or supplier preferences.

The targeted RFQ section may also contain one or more hyperlinks 430, 435 that allow the supplier to search various RFQs. For example, a hyperlink 430 may present the supplier with an “all open RFQs” search page that preferably requests the user to select various attributes upon which to search (e.g., forge type and the material). The forge type may appear as a list of selectable or hyperlinked words, but the list may also be one or more pull-down menus, tables, buttons, or other selectable devices. Types of forging that may be selected may include “open die,” “closed die,” “rolled ring,” and/or “cold forging.” The supplier may also be required to enter the material or composition of the forging it wishes to search for. This may be entered manually with a keyboard or similar device, but may also be entered with a list of selectable or hyperlinked words, one or more pull-down menus, tables, buttons, or other selectable device. After entering and/or selecting the required information, the supplier may “submit” the query by selecting a dialog button or other electronic selection device and receive search results from the system.

Similarly, the targeted RFQ section may also contain a hyperlink 435 that allows the supplier to search all the “closed-within-30-days” RFQs. Analogous to the open RFQ search page, when the hyperlink for closed-within-30-days RFQs link 435 is selected by the user, an RFQ search page may appear which requests the user to select the forge type and the material upon which to be searched. After entering and/or selecting the required information, the supplier may again submit the query to the system to receive the search results. The system preferably provides the search results to the supplier as a list (or table) of open RFQs for which the supplier may provide a bid or bids.

The supplier home page 400 may also provide a table or list 440 showing the supplier's open RFQ responses. This area 440 will preferably provide a list of open RFQs that the supplier has responded to. The list 440 may include information about the RFQs such as the nickname, RFQ, RFQ description, current price, status, and functions. These elements 440 of the list are preferably interactive in that the supplier may select on of the RFQs and receive more information about it.

Finally, there may be a hyperlink that will allow users to submit feedback about the site. This feedback may be collected by the system and used to provide a better online auction experience.

From their respective home pages, buyers and suppliers may utilize all of the features of the present invention that were described above. Some key elements of the present system may include: supplier's ability to submit multiple bids, increased bids, and self-adjusting bids; a buyers ability to accept any bid as the “winner;” the private auction centers and the personalized home pages of the present invention.

Nothing in the above description is meant to limit the present invention to any specific materials, geometry, or orientation of parts. Many parts/orientation methodology substitutions are contemplated within the scope of the present invention. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered by way of example only to facilitate comprehension of the invention and should not be construed to limit the scope thereof.

What is claimed is:

1. A method of electronically matching a buyer requesting a good with an entity capable of providing said good, comprising the steps of:
accepting a request for quote from the buyer describing the requested good;
posting the request for quote to at least one supplier to initiate a bidding process;
receiving at least one bid to supply said requested good from said at least one supplier; and
closing the bidding process so that no additional bids can be received.

2. The method of claim 1, wherein said request for quote includes a product specification with blue print drawings in an electronic format.

3. The method of claim 1, wherein said request for quote includes a country designation provided by the buyer which limits said posting step to suppliers from buyer-selected countries.

4. The method of claim 1, further comprising the step of:
receiving from the buyer an indication of a winning supplier bid, wherein said winning bid does not include the lowest price for which to provide said good.

5. The method of claim 1, wherein one of said at least one supplier may submit multiple bids in response to said request for quote.

6. The method of claim 5, wherein a second bid of said multiple bids from one of said at least one supplier includes a second pricing term that is greater than a first pricing term in a first bid from one of said at least one supplier, further wherein said second bid is received after said first bid is received.

7. The method of claim 1, wherein at least one received bid is self-adjusting.

8. The method of claim 1, wherein said closing step occurs in response to the expiration of a buyer-determined time to accept bids.

9. The method of claim 1, wherein said closing step occurs in response to an indication from the buyer that the bidding process should be closed before a preset time period for the bidding process expires.

10. The method of claim 1, further including the step of:
after said closing step, prompting the buyer to choose whether to reveal previously concealed identification information for all sellers that submitted bids.

11. The method of claim 10, wherein the buyer is contractually bound to purchase said good in response to the buyer's affirmative indication to reveal supplier identification information.

12. The method of claim 11, wherein the buyer is assessed a price quote fee in response to the buyer's negative indication to not reveal supplier identification information.

13. The method of claim 1, wherein said posting step comprises posting the request for quote only to a buyer-selected group of suppliers.

14. The method of claim 1, wherein said supplier bid is a no quote bid without any pricing information.

15. The method of claim 1, wherein said good is a customized forging.

16. The method of claim 15, wherein said request for quote includes a detailed specification of said forging.

17. A reverse auction purchasing system, comprising:
an information database; and
a web server capable of presenting and receiving electronic information to at least one supplier and at least one buyer, wherein said information includes personalized home pages.

18. The reverse auction system of claim 17, wherein said web server is capable of setting up a private auction center between a buyer and the buyer's pre-selected suppliers.

19. The reverse auction system of claim 17, wherein said personalized home pages include at least one buyer home page and at least one supplier home page.
